(19) United States
(12) Patent Application Publication
(10) Pub. No.: US 2019/0320616 A1
(43) Pub. Date: Oct. 24, 2019

(54) NAIL CLIPPER FOR PET ANIMALS HAVING CROSS ILLUMINATION LIGHTING

(71) Applicant: Naftoli Jacobowitz, Brooklyn, NY (US)

(72) Inventor: Naftoli Jacobowitz, Brooklyn, NY (US)

(21) Appl. No.: 16/390,272

(22) Filed: Apr. 22, 2019

Related U.S. Application Data
(60) Provisional application No. 62/660,949, filed on Apr. 21, 2018.

(51) Int. Cl. A01K 17/00; A45D 29/02; B26B 13/22; F21V 33/00; F21V 23/04

(52) U.S. Cl. CPC A01K 17/00; A45D 29/02; F21V 23/0414; F21V 33/004; B26B 13/22

(57) ABSTRACT

A nail clipper for pet animals is provided. The nail clipper includes opposing light sources configured on two arms. The light sources provide cross-illumination during use of the nail clipper. This cross-illumination lighting from each light source are configured to assist groomers or pet owners to carefully cut nails of pet animals especially during low lighting conditions and thereby avoiding injury to pet animals.

### CROSS-REFERENCE TO RELATED PATENT DOCUMENTS

This patent application claims the benefit of priority of U.S. Provisional Application No. 62/660,949, entitled “PET NAIL CLIPPER HAVING CROSS-ILLUMINATION LIGHTING,” filed Apr. 21, 2018, which are hereby incorporated herein by reference in its entirety

### FIELD OF THE INVENTION

The present invention relates generally to grooming tools for pets, and more particularly to a nail clipper for pet animals that utilizes a light source for facilitating cross illumination of a pet nail surface during use.

### BACKGROUND

There exists a substantial and growing commercial market for improved pet grooming tools due in part to pet owners' increasing awareness of the health benefits of having a well-groomed and clean pet animal. One important category of pet grooming includes regular nail clipping to maintain clean and short nails of a pet animal. Regular pet animal nail cutting prevents pets from bringing germs and dirt into a housing abode and from causing undue scratching and wear to floors, rugs, and furniture.

Unfortunately, pet animal nail clipping should occur on a regular and ongoing basis, oftentimes as much as twice a month or more. Many pet owners either cannot afford the time required from their work schedule or cannot afford the expense charged for the services of a professional pet groomer. For this reason, many pet owners have taken it upon themselves to perform relatively low maintenance grooming. However, most pet owners do not possess the proper expertise or appropriate technique, as amateur groomers, to avoid causing harm to pet animals when performing nail cutting.

Pet animals also often become frightened or feel uncomfortable by tools used for grooming or cutting nails. Frightened pets may move erratically in various directions in an effort to escape the grooming procedure, and this erratic movement may be dangerous to the pets as well as the pet owners/groomers. For example, the erratic movement by the pets may cause a cutting surface of the grooming tool to contact sensitive areas of the pets, which in turn may harm the pet animal. Importantly, cutting or trimming nails of pet animals becomes more challenging in low light conditions (when there is insufficient indoor or outdoor lighting) during which the pet owners perform the nail cutting.

Various types of grooming devices, such as scissors and nail clippers are available in the market for use to trim the nails or claws of pet animals. However, such devices require amateur groomers or pet owners to observe a high degree of care especially during low light conditions to prevent them from cutting sensitive tissue or skin of pet animals and causing extreme pain and bleeding to pet animals.

In light of the foregoing, there exists a need for a technically improved device and more reliable solution to solve the above-mentioned problems, such as the improved grooming device described and claimed herein, for pet animal nail cutting that is more user friendly and harm resistant to pet animals.

### BRIEF SUMMARY

Accordingly, provided is a nail clipping device or nail clipper for pet animals such as a dog, a cat or the like, wherein the nail clipper includes opposing light sources that provides cross-illumination during the uses of the device. This cross-illumination lighting assist the amateur pet groomers or pet owners to carefully clip or cut nails of their pet animals especially during low lighting conditions, avoiding any injury to the pet animals.

It is an objective of the present invention to provide a nail clipper that's ergonomically designed, single hand operated and enables the groomers or pet owners to effectively clip the nails of the pet animals at the desired length and prevent injury to the pet animals.

According to the preferred embodiments of the present invention, there is provided a pet animal nail clipper. The nail clipper includes a first arm having a first end and a second end. The first arm comprising a first handle portion, a first blade portion with a sharpened nail clipper surface, and a first light source configured within the first end thereof.

According to the preferred embodiments, the nail clipper further includes a second arm having a third end and a fourth end, the second arm comprising a second handle portion, a second blade portion with the sharpened nail clipper surface, and a second light source configured within the third end thereof, and wherein the second arm and the first arm are correspondingly disposed and pivotally connected to each other using a pivotal mechanism.

According to the preferred embodiments, the at least one of the first arm and the second arm also comprise at least one light source switch having at least two modes of operation for controlling illumination from a first light source and a second light source on a nail surface of a nail or claw of a pet animal, and wherein the illumination from the first light source and the second light source is delivered at an angle respective to the degree of depression of the first handle portion and the second handle portion of the first arm and the second arm by a user. The at least two modes of operation of the at least one light source switch comprises a first mode of operation that switches ON the first light source and the second light source to illuminate the nail surface of the nail or claw of the pet animal, and a second mode of operation that switches OFF the first light source and the second light source.

According to the preferred embodiments, the nail clipper further comprising a spring attached at the underside of the first arm at one end and at the underside of the second arm at the other end in proximity to the first end and the third end of the first arm and the second arm respectively. The spring biases the first handle portion and the second handle portion and also the first blade portion and the second blade portion away from one another during use of the nail clipper.

According to the preferred embodiments, the first light source and the second light source may comprise one or more halogen light emitting LEDs, incandescent light bulbs, and/or halogen lights.

According to the preferred embodiments, the illumination from the first light source and the second light source during the first mode of operation is at least one of a dispersed illumination or a spotlight illumination.

According to the preferred embodiments, the first arm and the second arm further comprising a locking mechanism for securely clamping the nail clipper, when not in use. The locking mechanism comprises: a notch located near the one end of the spring extending outward from the underside of the first arm; and a groove located near the other end of spring formed underside of the second arm for receiving and retaining the notch therein.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a perspective view of a nail clipper of the present invention, in accordance with an embodiment of the present invention;

FIG. 2 illustrates the nail clipper of FIG. 1 with a light source switch in its first mode of operation, in accordance with an embodiment of the present invention; and

FIG. 3 illustrates the nail clipper of the present invention in use.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a nail clipper for pet animals. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, other embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. Further, it should be noted that the terms, “trim”, “clip”, “cut”, and so on are interchangeably used for the purpose of this application.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, a nail clipper for cutting nails of pet animals. Unless stated otherwise, terms such as “first” and “second” are used to arbitrarily distinguish between the elements or entities. Thus, these terms are not necessarily intended to indicate temporal or other prioritization of such elements or priorities.

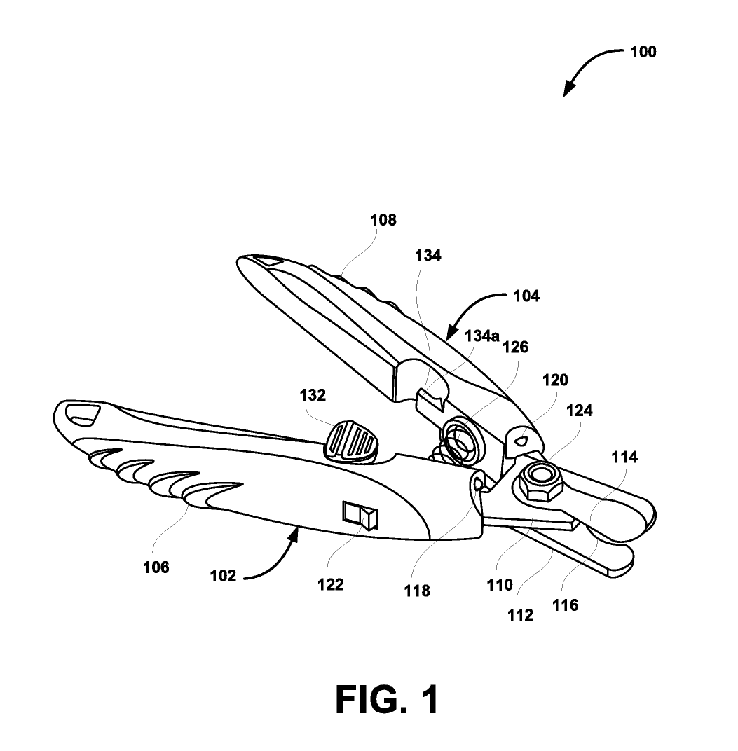

The various features and embodiments of the proposed grooming device, specifically a nail clipper will now be described in conjunction with the accompanying figures, namely FIGS. 1-3.

Referring to accompanying figures, a perspective view of a nail clipper 100 of the present invention is shown, in accordance with an embodiment of the present invention.

The first arm 102 includes two opposite ends, named as a first end and a second end. The first arm 102 includes a first handle portion 106, and a first blade portion 110. The blade portion 110 comprises a sharpened nail clipper surface 114. In an embodiment, the sharpened nail clipper surface 114 may be concavely shaped. In another embodiment, the sharpened nail clipper surface 114 may be flat rectangular shaped or any other shapes known in the art. The first arm 102 further includes a first light source 118 configured at the first end (on top) of the first arm 102 as shown in the FIG. 1. The first light source 118 includes but is not limited to one or more halogen light emitting LEDs, incandescent light bulbs, and halogen lights.

The second arm 104 includes two opposite ends, named as a third end and a fourth end. The second arm 104 includes a second handle portion 108, and a second blade portion 112. The blade portion 112 comprises a sharpened nail clipper surface 116. The second arm 104 further includes a second light source 120 configured at the third end (on top) of the second arm 104 as shown in FIG. 1. The second light source 120 includes but not limited to one or more halogen light emitting LEDs, incandescent light bulbs, and halogen lights.

According to the embodiment, the first arm 102 or the second arm 104 may include at least one light source switch 122. In the described embodiment, the switch 122 is shown configured on the arm 102. However, it should be understood, the switch 122 may be located at any suitable location on arms 102, 104. The switch 122 may be an electrical switch, an electronic switch, a mechanical switch, or a combination thereof. Although, the switch 122 shown in the FIG. 1 is push type switch, the switch 122 may be any other type of switch known in the art such as a slider switch and may be useful when the switch 122 has to operate in multiple modes of operation preferably more than two modes.

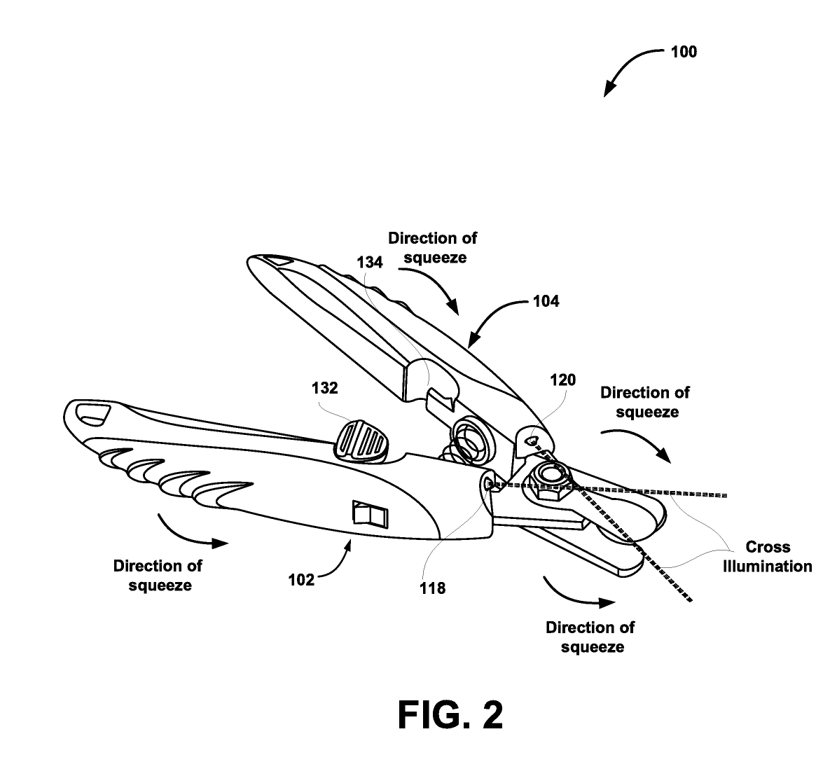

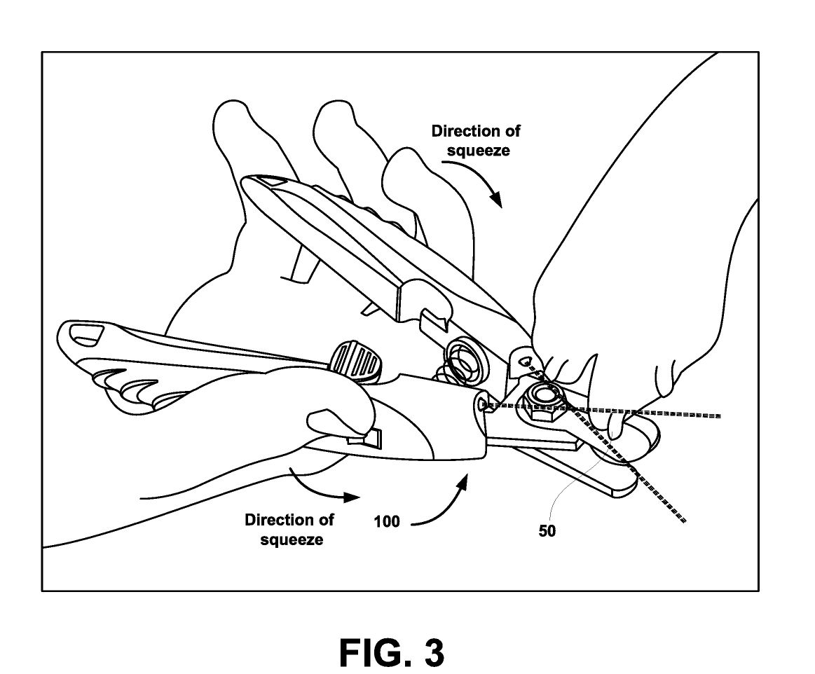

According to the embodiment, the switch 122 may have at least two modes of operations for controlling light illumination from the first light source 118 and the second light source 120. The light sources are oriented to illuminate a surface of a nail 50 or claw of a pet animal. The two modes of operation of the switch 122 includes a first mode of operation that switches ON the first light source 118 and the second light source 120 to illuminate the nail surface of the nail 50 or claw of the pet animal, and a second mode of operation that switches OFF the first light source 118 and the second light source 120. According to the embodiment, during the first mode of operation (when the light sources 118, 120 are in the ON state), the illumination from the light sources 118, 120 may be in the form of dispersed illumination, or in the form of spotlight (as shown in FIGS. 2-3 with dotted lines). Although in the preferred mode of operation, only two modes are described and disclosed, it should be understood that the nail clipper 100 of the present invention, in particular the switch 122, may be configured to operate in more than two modes, for example, an additional mode of operation may be provided where either of the two light sources 118, 120 is illuminated in a switchable form, or a mode of operation wherein the light sources 118, 120 may be illuminated for a specific time period, for example 1 minute and then become automatically switched off, or a mode of operation wherein only a portion of LED lights configured in each of the light sources 118,120 is illuminated.

The illumination from the first light source 118 and the second light source 120 is preferably delivered at an angle respective to the degree of depression of the first handle portion 106 and the second handle portion 108 of the first arm 102 and the second arm 104 respectively by a groomer. The angle at which the illumination may be delivered from the first light source 118 ranges from 0 degrees to 90 degrees to an X plane, whereas the angle at which the illumination may be delivered from the second light source 120 ranges from 270 degrees to 360 degrees to the X plane. In a preferred embodiment, light emitted or illuminated from the first light source 118 is delivered at 45 degrees to the X plane and light emitting or illuminated from the second light source 120 is delivered at 315 degrees to the X plane.

In terms of construction, it should be noted that each of the light sources 118, 120 may include one or more halogen light emitting LEDs configured on an LED panel (not shown) housed at the top end of the arms 102, 104. The LED's may be removably inserted into appropriate LED holes provided on respective the LED panels. Further, input terminals of each of the LED's constituting the light sources 118, 120 are connected to a power supply unit such as one or more batteries housed in the nail clipper 100. The batteries may be chargeable or non-chargeable batteries. Although not shown, the nail clipper 100 may be provided with battery location configured at some location to insert and remove the batteries. The ON-OFF of the LED's on the LED panels on the two arms 102, 104 are associated with modes of operation of the switch 122. For example, in the first mode of the switch 122, all the LED's in the two light sources 118, 120 are turned ON. In the second mode of the switch 122, all the LED's are turned OFF and thus the entire LED panels containing the LEDs does not emit any light.

As seen in FIG. 1, the first arm 102 and the second arm 104 are correspondingly disposed and pivotally connected to each other using a pivotal mechanism 124. The pivotal mechanism 124 may preferably include a pivot bolt and screw.

Further, as seen in the FIGS. 1-2, the nail clipper 100 includes a spring 126 attached underside the first arm 102 at its one end and underside to the second arm 104 at its other end in proximity to the first end and the third end of the first arm 102 and the second arm 104 respectively. The spring 126 biases or forces apart the first handle portion 106 and the second handle portion 108 and the first blade portion 110 and the second blade portion 112 away from one another during use of the nail clipper 100. The spring 126 helps reset the nail clipper 100 so that the groomer can cut or trim the next nail of the pet animal.

As seen in the FIG. 1, the nail clipper 100 further includes a locking mechanism 132, 134 for securely clamping the nail clipper 100, when the nail clipper 100 is not in use. To elaborate, the first arm 102 includes a notch 132 located near one end of the spring 126 and extending outward from the underside of the first arm 102. The second arm 104 includes a groove 134 located near other end of spring and formed underside of the second arm 104 for receiving and retaining the notch 132 therein. In terms of implementation, the notch 132 may be formed in several different shapes and sizes, and the groove 134 would then be configured in a shape and size so as to complement the shape and size of the notch 132 such that the groove can receive the notch 132 therein, and once received inside the groove 134, the notch 132 may be retained inside the groove 134 by means of some retaining provisions such as 134a.

In operation, assuming the nail clipper 100 is initially in a locked position (not shown), where the two arms 102, 104 are clamped together using the locking mechanism 132, 134. The groomer or the pet owner firstly unlocks the nail clipper 100 by removing the notch 132 out of the groove 134. Once the clipper 100 is unlocked (as shown in FIG. 1), the groomer can hold the clipper 100 using the two handles 106, 108. Next, the groomer can operate the switch 122 to operate it in first mode of operation or ON state that would activate the light sources 118, 120 configured on two top ends (referred as the first end and the third end) of the arms 102, 104 respectively. Once the switch 122 is operated in its first mode or ON state, the light sources 118, 120 are illuminated (as shown in FIG. 2) at an angle over the surface of the nail or area around the nail of the pet animal whose nail is to be trimmed or clipped. The illumination produced by the two light sources 118, 120 at the angle meet at a point crossing each other (termed as “cross illumination” for the purpose of this disclosure). The angle at which the illumination occurs from the two light sources 180,120 depends on the respective degree of depression of handles 106, 108 of the arms 102, 104 by the groomer. Next, once the light sources are illuminated, the groomer may place the sharpened nail clipper sections 114, 116 of the two blade portions 110,112 over a tip of the nail of the pet animal as shown in the FIG. 3 and squeeze the two handles 106, 108 together, to cut the nail of the pet animal. Once the intended nail is cut, the groomer can release the handles 106, 108 to reset the clipper 100, and repeat the clipping or trimming procedure for the next nail of the pet animal. Once the groomer is done with the nail trimming procedure, the groomer can operate the switch 122 to second mode of operation i.e OFF state, wherein the light sources 118,120 are switched off. The groomer then can squeeze the handles 106, 108 to direct the notch 132 back to the groove 134 to lock the clipper 100 again for storage, when the clipper 100 is not in use.

The nail clipper 100 of the present invention, and associated components described above may be made in different shapes and sizes using various materials known in the art such as, but not limited to, plastic, aluminum, copper, steel or iron or the like or any combination thereof.

Although particular embodiments of the invention have been described in detail for purposes of illustration, various modifications and enhancements may be made without departing from the spirit and scope of the invention.

What is claimed is:

1. A nail clipper (100) for cutting pet animal nails, comprising:
a first arm (102) having a first end and a second end, the first arm (102) comprising a first handle portion (106), a first blade portion (110) with a first sharpened nail clipper surface (114), and a first light source (118) configured within the first end thereof;
a second arm (104) having a third end and a fourth end, the second arm (104) comprising a second handle portion (108), a second blade portion (112) with a second sharpened nail clipper surface (116), and a second light source (120) configured within the third end thereof, and wherein the second arm (104) and the first arm (102) are correspondingly disposed and pivotally connected to each other using a pivotal mechanism (124); and
wherein, at least one of the first arm (102) and the second arm (104) having at least one light source switch (122) and at least two modes of operation for controlling illumination from the first light source (118) and the second light source (120) on a nail surface of a nail or claw of a pet animal, and wherein the illumination from the first light source (118) and the second light source (120) is delivered at an angle respective to the degree of depression of the first handle portion (106) and the second handle portion (108) of the first arm (102) and the second arm (104) by a user.

2. The nail clipper (100) of claim 1, wherein the pivotal mechanism (124) comprises a pivot bolt and screw.

3. The nail clipper (100) of claim 1, further comprising a spring (126) attached at the underside of the first arm (102) at one end and at the underside of the second arm (104) at other end in proximity to the first end and the third end of the first arm (102) and the second arm (104) respectively.

4. The nail clipper (100) of claim 3, wherein the spring (126) biases the first handle portion (106) and the second handle portion (108) and the first blade portion (110) and the second blade portion (112) away from each other during use of the nail clipper (100).

5. The nail clipper (100) of claim 1, wherein the first light source (118) and the second light source (120) comprises one or more halogen light emitting LEDs, incandescent light bulbs, and halogen lights.

6. The nail clipper (100) of claim 1, wherein the at least two modes of operations of the at least one light source switch comprises a first mode of operation that switches ON the first light source (118) and the second light source (120) to illuminate the nail surface of the nail or claw of the pet animal, and a second mode of operation that switches OFF the first light source (118) and the second light source (120).

7. The nail clipper (100) of claim 6, wherein the illumination from the first light source (118) and the second light source (120) during the first mode of operation is at least one of a dispersed illumination or a spotlight illumination.

8. The nail clipper (100) of claim 1, wherein the first arm (102) and the second arm (104) further comprising a locking mechanism (132, 134) for securely clamping the nail clipper (100), when not in use.

9. The nail clipper (100) of claim 8, wherein the locking mechanism (132, 134) comprises: a notch (132) located near the one end of the spring (126) and extending outward from the underside of the first arm (102); and a groove (134) located near the other end of the spring (126) and formed underside of the second arm (104) for receiving and retaining the notch (132) therein.

10. The nail clipper (100) of claim 1, wherein the angle at which the illumination is delivered from the first light source (118) ranges from 0 degrees to 90 degrees to an X plane.

11. The nail clipper (100) of claim 1, wherein the angle at which the illumination is delivered from the second light source (120) ranges from 270 degrees to 360 degrees to the X plane.
